(19) United States
(12) Patent Application Publication
(10) Pub. No.: US 2012/0257268 A1
(43) Pub. Date: Oct. 11, 2012

(54) ACTUATOR, OPTICAL SCANNER, AND IMAGE FORMING APPARATUS

(75) Inventors: Makiko HINO, Matsumoto (JP); Yasushi MIZOGUCHI, Suwa (JP)

(73) Assignee: SEIKO EPSON CORPORATION, Tokyo (JP)

(21) Appl. No.: 13/440,338

(22) Filed: Apr. 5, 2012

(30) Foreign Application Priority Data
Apr. 6, 2011 (JP) 2011-084839

(51) Int. Cl. G02B 26/10; H02K 33/16

(52) U.S. Cl. 359/214.1; 310/38

(57) ABSTRACT

An actuator includes a movable portion which can twist around an axis, a connecting portion which extends from the movable portion and is torsionally deformed according to the twisting of the movable portion, and a support portion which supports the connecting portion, wherein the movable portion has a cross shape in a plan view, and a cross-sectional width of the connecting portion perpendicular to the axis gradually increases from a first surface of the movable portion toward a second surface of the movable portion opposite the first surface.

### BACKGROUND

1. Technical Field

The present invention relates to an actuator, an optical scanner, and an image forming apparatus.

2. Related Art

An actuator which uses a torsional vibrator is known.

For example, JP-A-2010-79243 discloses an optical deflector which includes a movable plate, a support frame, and a pair of elastic support portions (connecting portions) which torsionally and rotatably support the movable plate with respect to the support frame. Each elastic support portion includes two beams.

The movable plate, the support frame, and the pair of elastic support portions are integrally formed by anisotropically etching a silicon substrate having a principal surface configured of a (100) plane of silicon.

In the optical deflector according to JP-A-2010-79243, the movable plate is shaped as an octagon in a plan view. This is advantageous because the weight of an octagonal movable plate at a position spaced apart from a rotation (swing) axis is relatively small. As such, the moment of inertia is decreased.

However, manufacturing a movable plate in an octagonal shape is difficult. Particularly, when the movable plate is manufactured by using anisotropic etching as described above, it is difficult to control the shape due to the relationship with the crystal plane. As such, there is a problem in that variations in the shape occur.

### SUMMARY

An advantage of some aspects of the invention is to provide an actuator, an optical scanner, and an image forming apparatus capable of decreasing a moment of inertia when a movable portion is swung by further decreasing variations in the shape of the movable portion during manufacture as compared with the related art.

An aspect of the invention is directed to an actuator including a movable portion which can twist around an axis, a connecting portion which extends from the movable portion and is torsionally deformed according to the twisting of the movable portion, and a support portion which supports the connecting portion, wherein the movable portion is formed in a cross shape in a plan view in a thickness direction of the movable portion, and a cross-section of the connecting portion perpendicular to the axis is formed in a shape in which a width of the connecting portion is gradually increased from a first surface of the movable portion toward a second surface of the movable portion opposite the first surface.

According to the actuator of the aspect of the invention, variation in shape of the movable portion in the manufacture is decreased, and it is possible to decrease a moment of inertia at the time of the twisting of the movable portion.

In the actuator of the aspect of the invention, it is preferred that an outer shape of the movable portion in a plan view is mainly configured of a line (edge portion) parallel to the axis and a line (another edge portion) perpendicular to the axis.

Thereby, variation in shape of the movable portion in the manufacture is decreased.

In the actuator of the aspect of the invention, it is preferred that the movable portion, the support portion, and the connecting portion are formed by anisotropically etching a silicon substrate.

Thereby, the variation in shape is decreased, and the movable portion, the support portion, and the connecting portion can be easily formed.

In the actuator of the aspect of the invention, it is preferred that the plate surface (the second surface) of the movable portion is configured of a (100) plane of silicon.

Thereby, by anisotropically etching the silicon substrate in which the plate surface is configured of the (100) plane, the variation in shape is decreased, and the movable portion, the support portion, and the connecting portion can be easily formed.

In the actuator of the aspect of the invention, it is preferred that side surfaces of the movable portion are mainly configured of a (111) plane of silicon.

Thereby, the (111) plane of silicon is used as a stop layer of etching by anisotropically etching the silicon substrate in which the plate surface is configured of the (100) plane, the variation in shape is decreased, and the movable portion, the support portion, and the connecting portion can be easily formed.

In the actuator of the aspect of the invention, it is preferred that a groove having a V shape in a cross-section perpendicular to the plate surface of the movable portion is formed in the side surfaces of the movable portion.

Thereby, it is possible to decrease the moment of inertia of the movable portion. In addition, in the groove, the (111) plane of silicon is used as a stop layer of etching by anisotropically etching the silicon substrate in which the plate surface is configured of the (100) plane, the variation in shape is decreased, and the movable portion can be easily formed.

In the actuator of the aspect of the invention, it is preferred that a surface of the connecting portion is configured of the (100) plane and the (111) plane of silicon.

Thereby, the (111) plane of silicon is used as the stop layer of etching, the variation in shape is decreased, and the connecting portion can be easily formed.

In the actuator of the aspect of the invention, it is preferred that the connecting portion includes two beams.

Thereby, since length of the connecting portion can be shortened, a size of the entire device can be decreased.

In the actuator of the aspect of the invention, it is preferred that a cross-section of each beam member perpendicular to the axis is formed as a parallelogram, and a distance between the two beam members may be gradually increased from the first surface of the movable portion toward the second surface thereof.

Due to the fact that the silicon substrate is anisotropically etched, the connecting portion can be easily formed collectively with the movable portion having a shape in the plan view of a cross shape or in which four corners of a quadrangle are removed in a rectangular shape.

In the actuator of the aspect of the invention, it is preferred that the cross-section of the connecting portion perpendicular to the axis is formed as a trapezoid.

Due to the fact that the silicon substrate is anisotropically etched, the connecting portion can be easily formed collectively with the movable portion having a shape in the plan view of a cross shape or in which four corners of a quadrangle are removed in a rectangular shape.

In the actuator of the aspect of the invention, it is preferred that the movable portion is formed in a shape which is symmetrical with respect to the axis in a plan view.

Thereby, the center of gravity of the movable portion is positioned on the axis of the movable portion, and the twisting of the movable portion can be smoothly performed.

In the actuator of the aspect of the invention, it is preferred that the movable portion is formed in a shape which is symmetrical with respect to a line which passes through a center of the movable portion and is perpendicular to the axis in a plan view.

Thereby, design of the movable portion can be easily performed.

Another aspect of the invention is directed to an actuator including a movable portion which can twist around an axis, a connecting portion which extends from the movable portion and is torsionally deformed according to the twisting of the movable portion, and a support portion which supports the connecting portion, wherein the movable portion is formed in a shape in which each of the four corner-portions of a quadrangle is removed in a rectangular shape in a plan view in a thickness direction of the movable portion, and a cross-section of the connecting portion perpendicular to the axis is formed in a shape in which a width of the connecting portion is gradually increased from a first surface of the movable portion toward a second surface of the movable portion opposite the first surface.

According to the actuator of the aspect of the invention, variation in shape of the movable portion in the manufacture is decreased, and it is possible to decrease a moment of inertia at the time of the twisting of the movable portion.

Still another aspect of the invention is directed to an optical scanner including a movable portion which includes a light reflecting portion having light reflectivity and can twist around an axis, a connecting portion which extends from the movable portion and is torsionally deformed according to the twisting of the movable portion, and a support portion which supports the connecting portion, wherein the movable portion is formed in a cross shape in a plan view in a thickness direction of the movable portion, and a cross-section of the connecting portion perpendicular to the axis is formed in a shape in which a width of the connecting portion is gradually increased from a first surface of the movable portion toward a second surface of the movable portion opposite the first surface.

According to the optical scanner configured above, variation in shape of the movable portion in the manufacture is decreased, and it is possible to decrease a moment of inertia at the time of the twisting of the movable portion.

Yet another aspect of the invention is directed to an optical scanner including a movable portion which includes a light reflecting portion having light reflectivity and can twist around an axis, a connecting portion which extends from the movable portion and is torsionally deformed according to the twisting of the movable portion, and a support portion which supports the connecting portion, wherein the movable portion is formed in a shape in which each of the four corner-portions of a quadrangle is removed in a rectangular shape in a plan view in a thickness direction of the movable portion, and a cross-section of the connecting portion perpendicular to the axis is formed in a shape in which a width of the connecting portion is gradually increased from a first surface of the movable portion toward a second surface of the movable portion opposite the first surface.

According to the optical scanner configured above, variation in shape of the movable portion in the manufacture is decreased, and it is possible to decrease a moment of inertia at the time of the twisting of the movable portion.

Still yet another aspect of the invention is directed to an image forming apparatus including a light source which emits light, and an optical scanner which scans the light from the light source, wherein the optical scanner includes, a movable portion which includes a light reflecting portion having light reflectivity and can twist around an axis, a connecting portion which extends from the movable portion and is torsionally deformed according to the twisting of the movable portion, and a support portion which supports the connecting portion, the movable portion is formed in a cross shape in a plan view in a thickness direction of the movable portion, and a cross-section of the connecting portion perpendicular to the axis is formed in a shape in which a width of the connecting portion is gradually increased from a first surface of the movable portion toward a second surface of the movable portion opposite the first surface.

According to the image forming apparatus configured above, variation in shape of the movable portion in the manufacture is decreased, and it is possible to decrease a moment of inertia at the time of the twisting of the movable portion. Therefore, a high quality image can be inexpensively obtained.

Further another aspect of the invention is directed to an image forming apparatus including a light source which emits light, and an optical scanner which scans the light from the light source, wherein the optical scanner includes, a movable portion which includes a light reflecting portion having light reflectivity and can twist around an axis, a connecting portion which extends from the movable portion and is torsionally deformed according to the twisting of the movable portion, and a support portion which supports the connecting portion, the movable portion is formed in a shape in which each of four corner-portions of a quadrangle is removed in a rectangular shape in a plan view in a thickness direction of the movable portion, and a cross-section of the connecting portion perpendicular to the axis is formed in a shape in which a width of the connecting portion is gradually increased from a first surface of the movable portion toward a second surface of the movable portion opposite the first surface.

According to the image forming apparatus configured above, variation in shape of the movable portion in the manufacture is decreased, and it is possible to decrease a moment of inertia at the time of the twisting of the movable portion. Therefore, a high quality image can be inexpensively obtained.

### BRIEF DESCRIPTION OF THE DRAWINGS

The invention will be described with reference to the accompanying drawings, wherein like numbers reference like elements.

FIG. 1 is a plan view showing an optical scanner (actuator) according to a first embodiment of the invention.

FIG. 2 is a cross-sectional view taken along a line A-A of FIG. 1.

FIG. 3 is a plan view illustrating a movable plate included in the optical scanner shown in FIG. 1.

FIG. 4 is a cross-sectional view taken along a line B-B of FIG. 1.

FIG. 5 is a partially enlarged cross-sectional view of FIG. 4.

FIGS. 6A to 6G are cross-sectional views illustrating a method of manufacturing the optical scanner shown in FIG. 1.

FIGS. 7A to 7G are cross-sectional views illustrating a method of manufacturing the optical scanner shown in FIG. 1.

FIGS. 8A to 8G are cross-sectional views illustrating a method of manufacturing the optical scanner shown in FIG. 1.

FIGS. 9A to 9D are views illustrating the formation of a connecting portion (when mask misalignment is not present) in an etching process shown in FIG. 8E.

FIGS. 10A to 10D are views illustrating the formation of the connecting portion (when mask misalignment is present) in the etching process shown in FIG. 8E.

FIG. 11 is a plan view showing an optical scanner according to a second embodiment of the invention.

FIG. 12 is a partially enlarged cross-sectional view taken along a line B-B of FIG. 11.

FIG. 13 is a plan view illustrating a movable plate included in a scanner according to a third embodiment of the invention.

FIG. 14 is a plan view illustrating a movable plate included in a scanner according to a fourth embodiment of the invention.

FIG. 15 is a schematic view showing an example of an image forming apparatus of the invention.

### DESCRIPTION OF EXEMPLARY EMBODIMENTS

Hereinafter, preferred embodiments of an actuator, an optical scanner, and an image forming apparatus of the invention will be described with reference to the accompanying drawings. In addition, a case where the actuator of the invention is applied to an optical scanner is described as an example.

### First Embodiment

First, a first embodiment of the optical scanner of the invention is described.

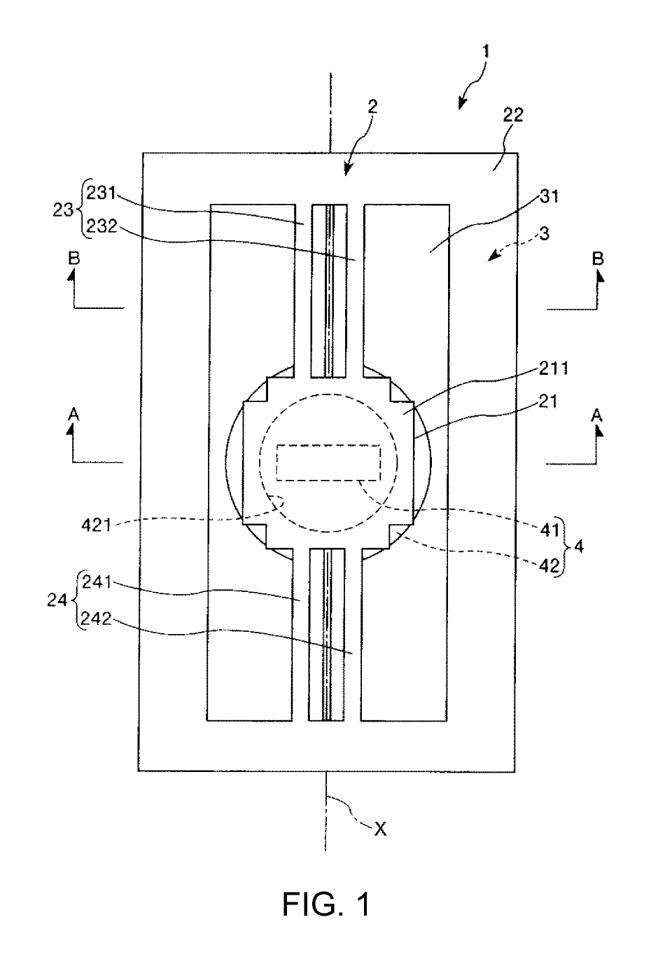

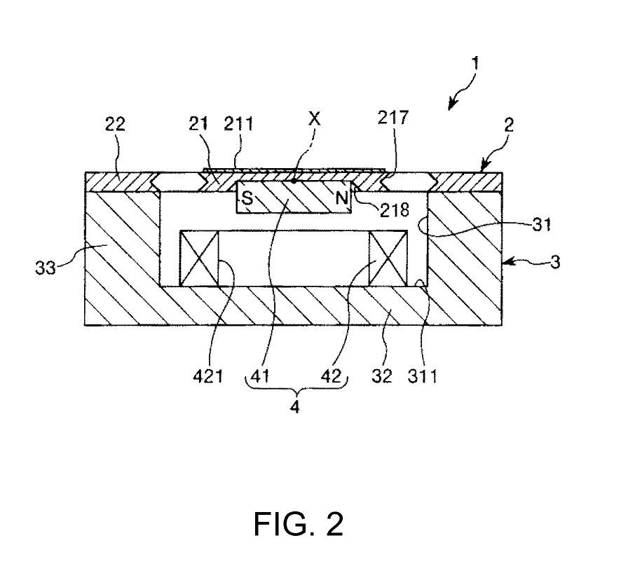

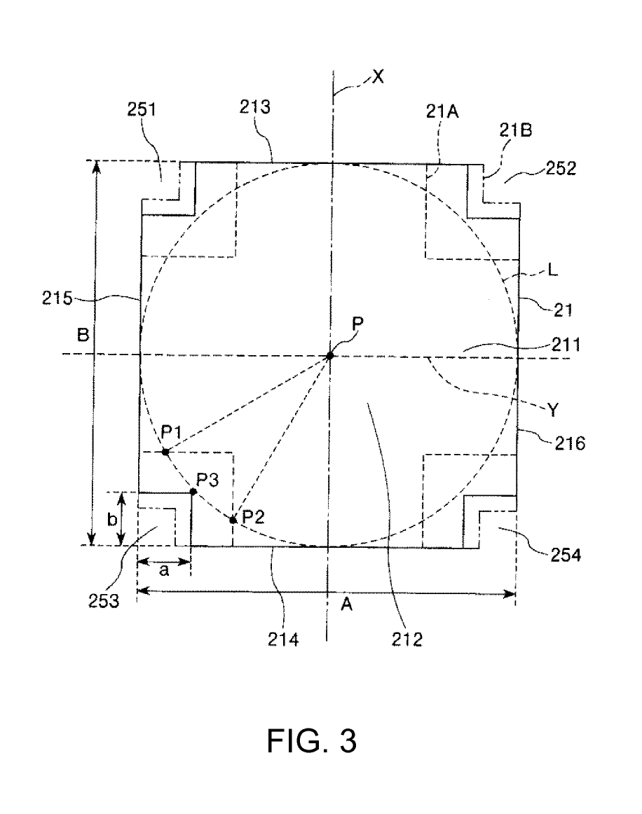

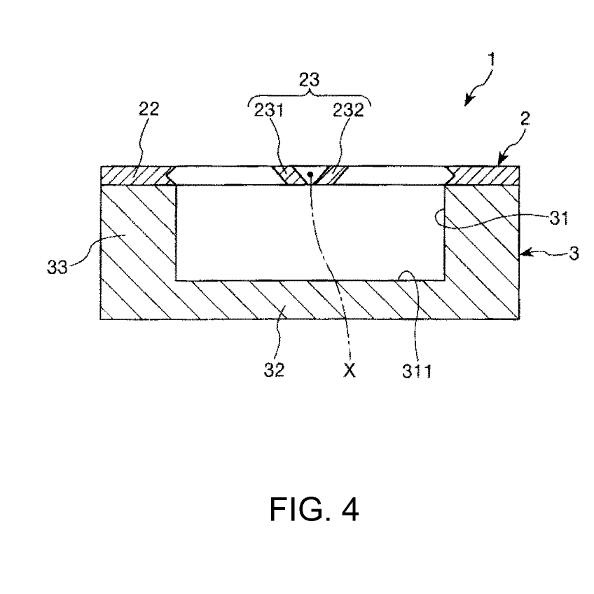

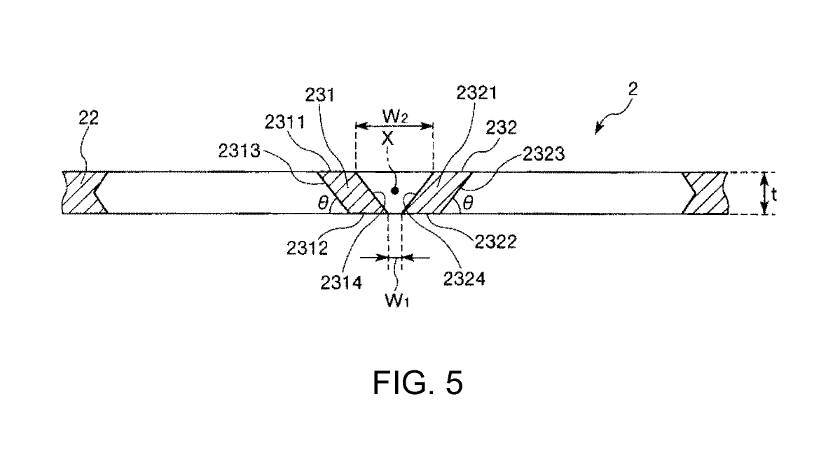

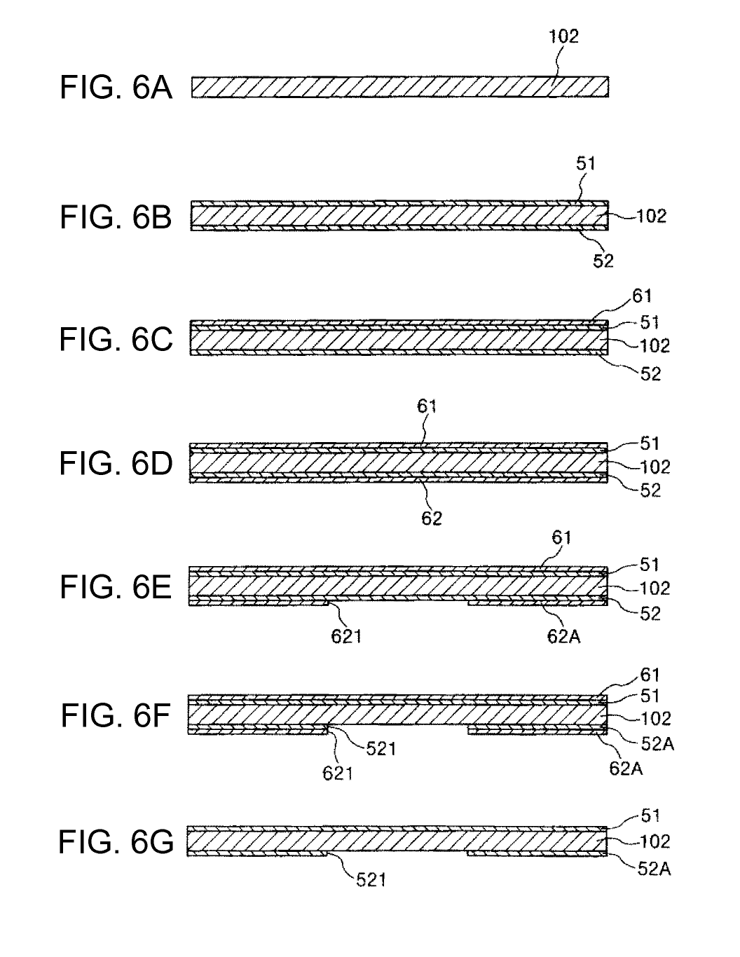

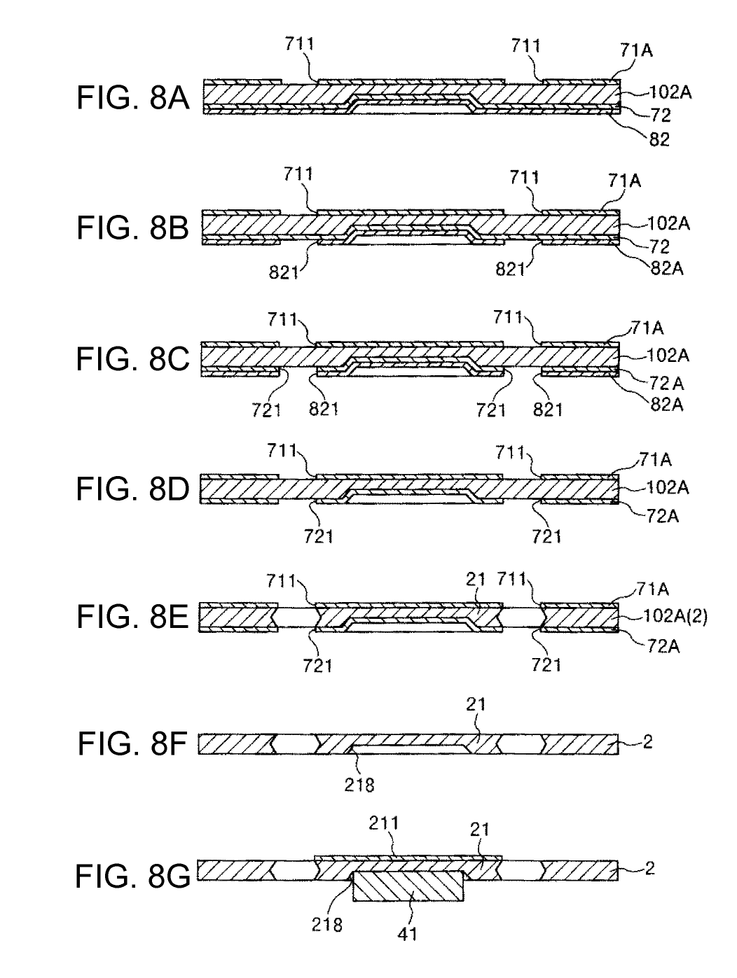

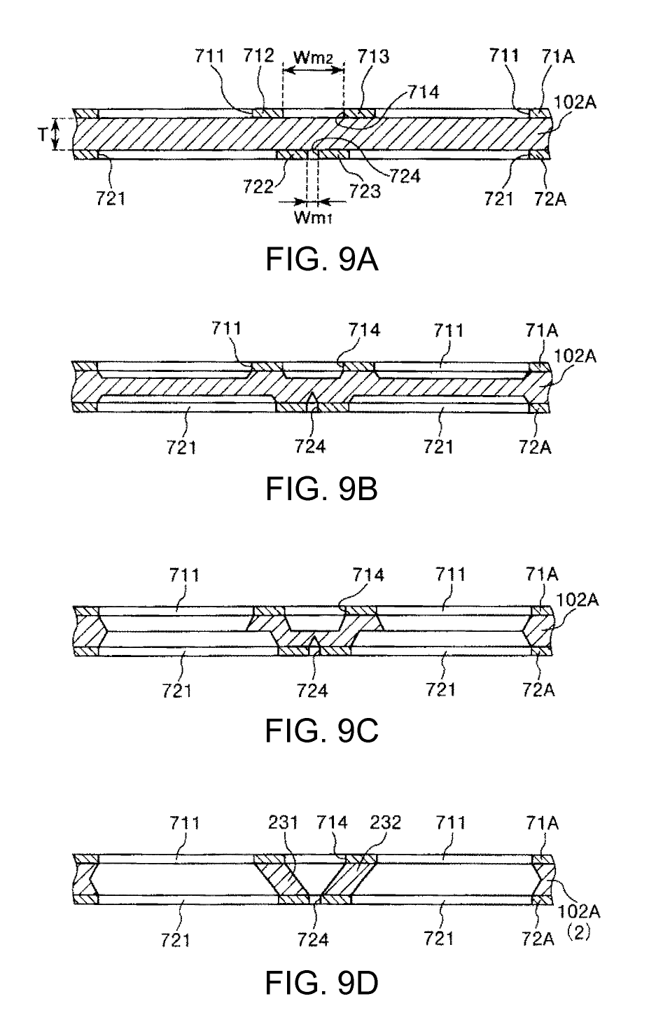

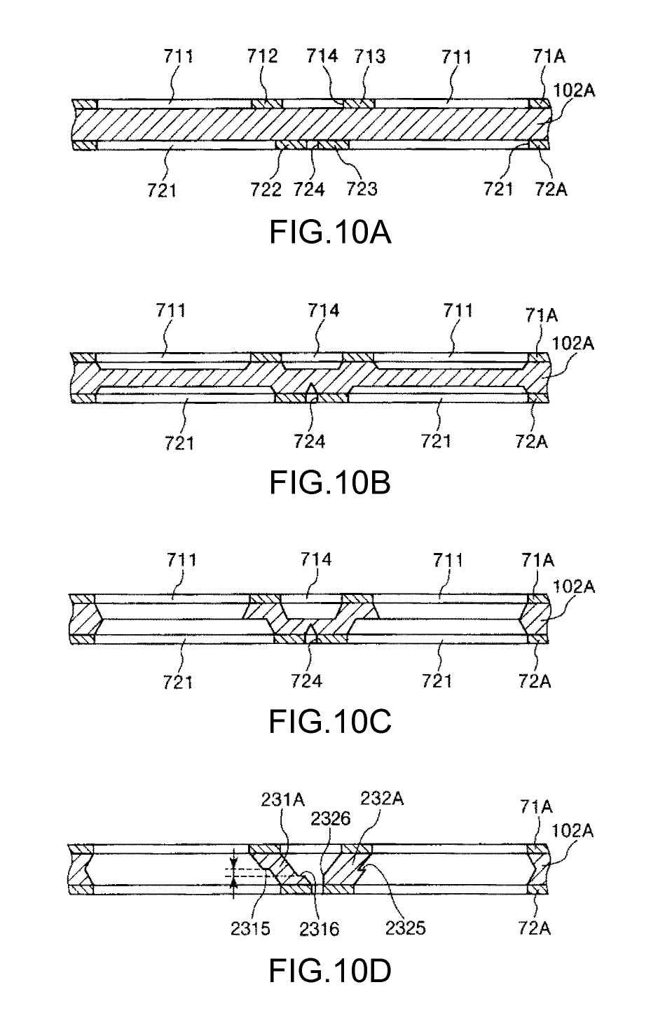

FIG. 1 is a plan view showing the optical scanner (actuator) according to the first embodiment of the invention, FIG. 2 is a cross-sectional view taken along a line A-A of FIG. 1, FIG. 3 is a plan view illustrating a movable plate included in the optical scanner shown in FIG. 1, FIG. 4 is a cross-sectional view taken along a line B-B of FIG. 1, and FIG. 5 is a partially enlarged cross-sectional view of FIG. 4. FIGS. 6A to 6G, FIGS. 7A to 7G and FIGS. 8A to 8G are cross-sectional views illustrating a method of manufacturing the optical scanner shown in FIG. 1. FIGS. 9A to 9D are views illustrating the formation of a connecting portion (when mask misalignment is not present) in an etching process shown in FIG. 8E, and FIGS. 10A to 10D are views illustrating the formation of the connecting portion (when mask misalignment is present) in the etching process shown in FIG. 8E. Hereinafter, for the sake of convenience of explanation, the upper side in FIGS. 2 and 4 to 10 is referred to as “up” and the down side is referred to as “down”.

As shown in FIG. 1, an optical scanner 1 includes a base body 2 including a vibration system, a support body 3 which supports the base body 2, and a driving portion 4 which vibrates the vibration system of the base body 2.

In addition, the base body 2 includes a movable plate (movable portion) 21 in which a light reflecting portion 211 is provided, a pair of connecting portions 23 and 24 which are connected to the movable plate 21, and a support portion 22 which supports the pair of connecting portions 23 and 24. The support portion 22 supports the movable plate 21 via the pair of connecting portions 23 and 24, and the pair of connecting portions 23 and 24 connect the movable plate 21 and the support portion 22.

In the optical scanner 1, a driving force of the driving portion 4 rotates (swings) the movable plate 21 around a predetermined axis (center axis of rotation) along the connecting portions 23 and 24 while torsionally deforming each connecting portion 23 and 24. Thereby, light which is reflected by the light reflecting portion 211 can scan in predetermined directions.

Hereinafter, each portion configuring the optical scanner 1 will be sequentially described in detail.

### Base Body

As described above, the base body 2 includes the movable plate 21 in which the light reflecting portion 211 is provided, the support portion 22 which supports the movable plate 21, and the pair of connecting portions 23 and 24 which connect the movable plate 21 and the support portion 22.

The base body 2 is configured of silicon as the main material, and the movable plate 21, the support portion 22, and the connecting portions 23 and 24 are integrally formed. More specifically, as described hereinafter, the base body 2 is formed by anisotropically etching a silicon substrate in which the plate surface is configured of a (100) plane of silicon. According to the anisotropic etching, it is possible to form the movable plate 21, the support portion 22, and the pair of connecting portions 23 and 24 simply and with high accuracy while using a (111) plane of silicon as an etching stop layer. In addition, in general, a single crystal silicon substrate is used as the silicon substrate.

Moreover, each of an upper surface and a lower surface of the base body 2 is configured of the (100) plane of silicon. In addition, an inner circumferential surface of the support portion 22, a side surface of the movable plate 21, and portions which are parallel to an axis line X of the side surfaces of each connecting portion 23 and 24 are configured of the (111) plane of silicon respectively.

Moreover, since the silicon is lightweight and has the same rigidity as a SUS, due to the fact that the base body 2 is configured of silicon as the main material, the base body 2 having improved vibration characteristics can be obtained. In addition, as described below, since the silicon can be processed with highly precise dimensional accuracy by etching, it is possible to obtain the base body 2 having a desired shape (desired vibration characteristics) by forming the base body 2 using the silicon substrate.

Hereinafter, the base body 2 will be described in more detail.

As shown in FIG. 1, the support portion 22 is formed in a frame shape. More specifically, the support portion 22 is formed in a rectangular or square ring shape. The support portion 22 supports the movable plate 21 via the pair of connecting portions 23 and 24. Moreover, the shape of the support portion 22 is not particularly limited as long as it is capable of supporting the movable plate 21 via the pair of connecting portions 23 and 24. For example, the support portion may be formed in a shape which is divided corresponding to each connecting portion 23 and 24.

The movable plate 21 is provided in the interior of the support portion 22.

The movable plate 21 is formed in a plate shape. Moreover, in the embodiment, the movable plate 21 is formed in a shape (cross shape) in which each of the four corners of a quadrangle (square in the embodiment) is removed in a plan view in the thickness direction of the movable plate 21. Thereby, a moment of inertia when the movable plate 21 is rotated (twisted) can be decreased while an area (light reflection region) of the light reflecting portion 211 of the upper surface of the movable plate 21 is sufficiently secured. Moreover, as described hereinafter, the movable plate 21 can be simply formed with high accuracy by anisotropically etching the silicon substrate.

More Specifically, as shown in FIG. 3, the movable plate 21 includes a main body portion 212, a pair of protrusions 213 and 214 which protrude from the main body portion 212 to both sides in a direction parallel to the axis line X, and a pair of protrusions 215 and 216 which protrude from the main body portion 212 to both sides in a direction (direction parallel to a line Y) perpendicular to the axis line X. Thereby, the movable plate 21 is formed in a cross shape in a plan view.

In addition, a removed portion 251 is located between the protrusion 213 and the protrusion 215 in a direction along an outer circumference of the movable plate 21. Moreover, a removed portion 252 is located between the protrusion 213 and the protrusion 216 in a direction along an outer circumference of the movable plate 21. In addition, a removed portion 254 is located between the protrusion 214 and the protrusion 216 in a direction along an outer circumference of the movable plate 21. Moreover, a removed portion 253 is located between the protrusion 214 and the protrusion 215 in a direction along an outer circumference of the movable plate 21.

In other words, in a plan view in the thickness direction of the movable plate 21, the removed portion 251, the protrusion 213, the removed portion 252, the protrusion 216, the removed portion 254, the protrusion 214, the removed portion 253, and the protrusion 215 are provided side by side in this order along the outer circumference of the movable plate 21.

Moreover, the removed portion 251 and the removed portion 252 face each other via the protrusion 213. In addition, the removed portion 252 and the removed portion 254 face each other via the protrusion 216. Moreover, the removed portion 253 and the removed portion 254 face each other via the protrusion 214. In addition, the removed portion 251 and the removed portion 253 face each other via the protrusion 215.

The protrusions 213 to 216 and the removed portions 251 to 254 are each formed in a quadrangle in a plan view in the thickness direction of the movable plate 21. In addition, in FIGS. 1 and 3, the state in which the shape in a plan view of each of removed portions 251 to 254 forms a square is shown as an example. Moreover, corners in the shape in a plan view of the protrusions 213 to 216 and the removed portion 251 to 254 may be rounded. Moreover, in the corners in the outer shape of the cross shape of the movable plate 21, since not only a predetermined crystal plane but also a plurality of crystal planes appear, in some cases, the corners are not strictly a right angle, and the protrusions 213 to 216 and the removed portions 251 to 254 are not strictly a quadrangle. However, in the embodiment, each of the removed portions 251 to 254 including the above-described state is considered to be a quadrangle.

The outer shape in the plan view in the thickness direction of the movable plate 21 is mainly configured of a line parallel to the center axis of rotation (axis line X) of the movable plate 21 and a line (line Y) perpendicular to the center axis of rotation (swing axis: axis line X) of the movable plate 21. Thereby, as described hereinafter, the movable plate 21 can be simply formed with high accuracy by anisotropically etching the silicon substrate. Moreover, not only a predetermined crystal plane but also a plurality of crystal planes appear in the corners in the outer shape of the cross shape of the movable plate 21. Accordingly, in some cases, the outer shape of the corners in a plan view in the thickness direction of the movable plate 21 is not formed in lines parallel to the axis line X or the line Y. That is, the outer shape in a plan view in the thickness direction of the movable plate 21 is configured of the line parallel to the axis line X and the line parallel to the line Y at least except the corners of the movable plate 21.

Moreover, the movable plate 21 is formed in a shape which is symmetrical with respect to the center axis of rotation (axis line X) of the movable plate 21 in a plan view. Thereby, the center of gravity of the movable plate 21 is simply positioned on the center axis of rotation of the movable plate 21, and the rotation of the movable plate 21 can be smoothly performed.

In addition, the movable plate 21 is formed in a shape which is symmetrical with respect to the line Y, which passes through a center P of the movable plate 21 and is perpendicular with respect to the center axis of rotation (axis line X) of the movable plate 21 in a plan view. Thereby, design of the movable plate is easily performed.

Moreover, the plate surface of the movable plate 21 is configured of the (100) plane of silicon. Thereby, as described hereinafter, the movable plate 21, the support portion 22, and the pair of connecting portions 23 and 24 can be simply configured with high accuracy by anisotropically etching the silicon substrate in which the plate surface is configured of the (100) plane.

In addition, side surfaces of the movable plate 21 are mainly configured of the (111) plane of silicon. Thereby, as described hereinafter, the movable plate 21, the support portion 22, and the pair of connecting portions 23 and 24 can be simply formed with high accuracy using the (111) plane of silicon as the etching stop layer by anisotropically etching the silicon substrate in which the plate surface is configured of the (100) plane. Moreover, the side surfaces of the movable plate 21 include crystal planes other than the (111) plane in the corners of the outer shape in a plan view in the thickness direction of the movable plate 21. Accordingly, the side surfaces of the movable plate 21 are configured of the (111) plane of silicon except at least for the side surfaces at the corners.

In addition, a groove 217 having a V shape in a cross-section perpendicular to the plate surface of the movable plate 21 is formed in the side surfaces of the movable plate 21. Thereby, the moment of inertia of the movable plate 21 can be decreased. In addition, the groove can be simply formed with high accuracy using the (111) plane of silicon as the etching stop layer by anisotropically etching the silicon substrate in which the plate surface is configured of the (100) plane.

In addition, when a length in a direction (hereinafter, also referred to as a “direction of the line Y”) perpendicular to the center axis of rotation (axis line X) in a plan view in the thickness direction of the movable plate 21 is A, a length in a direction (hereinafter, also referred to as a “direction of the axis line X”) parallel to the center axis of rotation (axis line X) of the movable plate 21 is B, a length along the direction of the line Y of each of removed portions 251 to 254 is a, and a length along the direction of the axis line X of each of removed portions 251 to 254 is b, the following equations (A) and (B) are satisfied.

$$\begin{matrix}0.8 \times \{ \frac{1}{2} ( A - \sqrt{\frac{1}{\frac{3}{{A}^{2}} + \frac{1}{{B}^{2}}}} ) \} \leq a \leq 2.0 \times \{ \frac{1}{2} ( A - \sqrt{\frac{1}{\frac{1}{3 {A}^{2}} + \frac{1}{{B}^{2}}}} ) \} & ( A ) \\ 0.8 \times \{ \frac{1}{2} ( B - \sqrt{\frac{1}{\frac{1}{3 {A}^{2}} + \frac{1}{{B}^{2}}}} ) \} \leq b \leq 2.0 \times \{ \frac{1}{2} ( B - \sqrt{\frac{1}{\frac{3}{{A}^{2}} + \frac{1}{{B}^{2}}}} ) \} & ( B )\end{matrix}$$

Due to the fact that equations (A) and (B) are both satisfied, the moment of inertia when the movable plate 21 is rotated can be effectively decreased while an area which is desired for the light reflection in the light reflecting portion 211 of the movable plate 21 is secured.

In contrast, if the lengths a and b are less than the lower limit, the effects of decreased moments of inertia when the movable plate 21 is rotated may be reduced respectively. Thereby, according to the thickness of the movable plate 21, the dynamic deflection of the movable plate 21 may be increased, and the optical characteristics of the optical scanner 1 may be decreased.

On the other hand, if the lengths a and b are greater than the upper limit, the area of the light reflecting portion 211 of the movable plate 21 cannot be effectively used, and the intensity of the reflected light at the light reflecting portion 211 may be decreased.

Moreover, in FIG. 3, a movable plate 21A in the case where the equations (A) and (B) are satisfied and each of a and b are the maximum, and a movable plate 21B in the case where the equations (A) and (B) are satisfied and each of a and b are the minimum are shown by dashed lines respectively.

Hereinafter, the equations (A) and (B) will be described.

As shown in FIG. 3, in a case where a circular or elliptical spot of light L is inscribed in the movable plate 21 in a plan view, the areas of each of removed portions 251 to 254 become the maximum at the outside of the spot of the light L when a=(1−1/√2)A and b=(1−1/√2)B.

Moreover, in this case, in a range in which the effects of forming the removed portions 251 to 254 are exerted, a is the maximum and b is minimum when a corner P3 of each of removed portions 251 to 254 is positioned at an intersection point P2 between a line inclined by 30° with respect to the axis line X and an outer circumference edge of the spot of the light L.

In addition, in this case, in the range in which the effects of forming the removed portions 251 to 254 are exerted, a is the minimum and b is maximum when the corner P3 of each of removed portions 251 to 254 is positioned at the intersection point P1 between a line inclined by 60° with respect to the axis line X and the outer circumference edge of the spot of the light L.

In addition, in general, an effective range of the spot diameter of a laser which is generally used as the light L becomes a range of brightness which is equal to or greater than 1/e² of peak brightness. Therefore, an ideal light reflection can be performed if the effective range falls within the light reflecting portion 211.

However, in the actual laser, some light is present even outside of the effective range, and the laser is acceptable without any problems in actual use even though a and b are slightly smaller or greater with respect to the value.

Specifically, the allowed values of a and b which are obtained as described above may be −20% or more and +200% or less.

From the above, the equations (A) and (B) can be obtained.

Moreover, in the movable plate 21, the lengths A and B may be equal to or different from each other. In addition, in FIG. 1, the case of A=B is shown.

The light reflecting portion 211 having light reflectivity is provided on the upper surface of the movable plate 21. On the other hand, a permanent magnet 41 of the driving portion 4 described below is provided on the lower surface of the movable plate 21. In addition, the permanent magnet 41 will be described in detail in a description of the driving portion 4 hereinafter.

The connecting portions 23 and 24 are each formed in a longitudinal shape and configured so as to be elastically deformable. In addition, the connecting portion 23 and the connecting portion 24 face each other via the movable plate 21. The connecting portions 23 and 24 each connect the movable plate 21 and the support portion 22 so that the movable plate 21 is rotatable with respect to the support portion 22. The pair of connecting portions 23 and 24 are coaxially provided along the axis line X, and the movable plate 21 is rotated with respect to the support portion 22 with the axis line X as the center axis of rotation.

In the embodiment, as shown in FIG. 1, the connecting portion 23 is configured of a pair of beam members 231 and 232. Similarly, the connecting portion 24 is configured of a pair of beam members 241 and 242.

In the connecting portions 23 and 24 which are configured in this way, the length can be shorter as compared with the case where the connecting portion is configured singly, and the area in a plan view in the plate thickness direction of the optical scanner 1 can be decreased. Hereinafter, the connecting portion 23 will be described as a representative; since the connecting portion 24 is similar to the connecting portion 23, the description thereof is omitted.

Each of the beam members 231 and 232 is provided along the axis line X and face each other via the axis line X. Moreover, the cross-sectional shape of each of the beam members 231 and 232 is formed as a parallelogram.

More specifically, the outer shapes of the cross-sections of the beam members 231 and 232 are formed as a parallelogram which includes a pair of sides along the (100) plane of silicon and a pair of sides along the (111) plane of silicon respectively. That is, in the beam member 231, an upper surface 2311 and a lower surface 2312 are each configured of the (100) plane of silicon, and a pair of side surfaces 2313 and 2314 are each configured of the (111) plane of silicon. Similarly, in the beam member 232, an upper surface 2321 and a lower surface 2322 are each configured of the (100) plane of silicon, and a pair of side surfaces 2323 and 2324 are each configured of the (111) plane of silicon. Here, since the side surfaces 2313, 2324, 2323, and 2324 are each configured of the (111) plane of silicon, an angle θ which is inclined with respect to the upper surface or the lower surface (that is, (100) plane of silicon) of the base body 2 becomes 54.73°. Each of the beam members 231 and 232 having the above-described cross-sectional shape can be simply and reliably formed by anisotropically etching the silicon substrate in which the plate surface is configured of the (100) plane of silicon.

In this way, if the outer surfaces of the connecting portion 23 are configured of the (100) plane and the (111) plane of silicon, as described below, the connecting portion 23 can be simply formed with high accuracy using the (111) plane of silicon as the stop layer of the etching.

In addition, when viewed from a direction parallel to the axis line X (in other words, when viewed from the cross-section shown in FIG. 5), the beam members 231 and 232 are formed in a shape which is symmetrical with respect to a line which vertically extends and passes through the axis line X.

Moreover, in the cross-section shown in FIG. 5, a width of the entire connecting portion 23 (face-to-face distance between side surface 2313 of the beam member 231 and side surface 2323 of the beam member 232) is widened (gradually increased) from the lower side toward the upper side. In addition, the width of the entire connecting portion 23 is a width at the time of connecting the beam member 231 and the beam member 232 and considering the connecting portion 23 as single member, and is a distance between two surfaces which configure the connecting portion 23 and are farthest separated from the center axis of rotation in the direction perpendicular to the center axis of rotation.

Moreover, in the cross-section shown in FIG. 5, the distance (width of gap) between the beam member 231 and the beam member 232 is lengthened (gradually increased) from the lower side toward the upper side. In addition, the distance between the beam member 231 and the beam member 232 indicates a distance between the surface (side surface 2314) of the beam member 231 and the surface (side surface 2324) of the beam member 232 which face each other while interposing the center axis of rotation in the direction parallel to the plate surface of the movable plate 21.

That is, when viewed from the direction parallel to the center axis of rotation of the movable plate 21, the distance between the pair of the beam members 231 and 232 is gradually increased from a side of one side surface toward a side of the other side surface (from the lower side toward the upper side in the embodiment) of the movable plate 21.

The connecting portion 23 can be simply formed with high accuracy by anisotropically etching the silicon substrate described hereinafter collectively with the movable plate 21 having the shape in a plan view described above.

In addition, the following equation (1) is satisfied when a distance between the ends of the lower sides of the pair of beam members 231 and 232 is W₁ and a thickness in the thickness direction of the movable plate 21 of the pair of beam members 231 and 232 is t.

$${w}_{1} < \frac{t}{tan 54.73 °} \qquad ( 1 )$$

As described in more detail below, since the silicon substrate, in which the plate surface is configured of the (100) plane of silicon, is anisotropically etched from both surface sides, when the movable plate 21, the support portion 22, and the pair of connecting portions 23 and 24 are formed, the formation positions of the masks which are formed on both surfaces of the silicon substrate may be deviated. In this way, if the formation positions of the masks of both surfaces of the silicon substrate are deviated from each other, a step is generated in the pair of side surfaces 2313, 2314, 2323, and 2324 which are to be configured on the (111) plane of silicon of each of beam members 231 and 232. When the formation positions of the masks formed on both surfaces of the silicon substrate are deviated from each other, due to the fact that equation (1) is satisfied, the step which is formed on the side surface of one side and the step which is formed on the side surface of the other side can be shifted in the thickness direction of the silicon substrate (refer to FIGS. 10A to 10D). Thereby, stress concentration which is generated in each of the beam members 231 and 232 when the movable plate 21 is rotated can be alleviated.

In this way, in the optical scanner 1, damage due to the stress concentration at the time of the driving the optical scanner can be relatively simply prevented.

In addition, the following equation (2) is satisfied when a distance between ends of the upper sides of the pair of beam members 231 and 232 is W₂.

$$t < \frac{tan 54.73 °}{2} ( {w}_{1} + {w}_{2} ) \qquad ( 2 )$$

Thereby, the connecting portion 23 which is configured of the pair of beam members 231 and 232 can be simply and reliably formed by anisotropically etching the silicon substrate, in which the plate surface is configured of the (100) plane of silicon, from both surface sides.

### Support Body

The support body 3 supports the above-described base body 2. Moreover, the support body 3 supports a coil 42 of the driving portion 4 described below.

The support body 3 is formed in a box shape including a concave portion 31 which opens upwardly. In other words, the support body 3 includes a plate-shaped portion 32 which is formed in a plate shape, and a frame-shaped portion 33 which is provided along the outer circumference portion of the upper surface of the plate-shaped portion 32 and is formed in a frame shape.

The lower surface of the support portion 22 of the above-described base body 2 is bonded to a portion outside the concave portion 31 among the upper surfaces of the support body 3, that is, on the upper surface of the frame-shaped portion 33. Thereby, a space which allows rotation of the movable plate 21 is located between the movable plate 21 and the pair of connecting portions 23 and 24 of the base body 2 and the support body 3.

A constituent material of the support body 3 is not particularly limited. For example, the constituent material may include a glass material such as quartz glass, Pyrex Glass (“Pyrex” is a trademark), or TEMPAX glass, a silicon material such as single crystal silicon, or poly silicon, a LTCC (low temperature sintering ceramics), or the like.

In addition, the method of bonding the base body 2 and the support body 3 can be appropriately determined according to the constituent material of the support body 3, the shape, or the like, and is not particularly limited. The bonding method may include a method using an adhesive, an anodic bonding method, a direct bonding method, or the like.

### Driving Portion

The driving portion 4 includes the permanent magnet 41 and the coil 42 and rotatably drives the above-described movable plate 21 of the base body 2 by an electromagnetic drive system (more specifically, a moving magnet type electromagnetic drive system). The electromagnetic drive system can generate a great driving force. Thereby, according to the driving portion 4 which adopts the electromagnetic drive system, a deflection angle of the movable plate 21 can be greater while a lower driving voltage is improved.

For example, the permanent magnet 41 is fixed to the lower surface of the movable plate 21 through an adhesive. Moreover, the magnet 41 is formed in a longitudinal shape and is provided so as to extend in the direction perpendicular with respect to the axis line X in a plan view. The permanent magnet 41 is magnetized in a longitudinal direction, and one side in the longitudinal direction becomes an S pole and the other side becomes an N pole. The permanent magnet 41 is provided so as to extend in the direction perpendicular with respect to the axis line X, and therefore, both ends of the permanent magnet 41 can be positioned away from the axis line X. Thereby, great torque can be applied by the movable plate 21 through the effects of a magnetic field which is generated by the coil 42.

The permanent magnet 41 is not particularly limited. For example, the permanent magnet may appropriately be those, in which a hard magnetic material is magnetized, such as a neodymium magnet, a ferrite magnet, a samarium-cobalt magnet, an alnico magnet, or a bonded magnet.

The coil 42 is provided on a lower surface 311 of the concave portion 31 of the support body 3 so as face the movable plate 21. Thereby, the magnetic field which is generated by the coil 42 can effectively act on the permanent magnet 41. The coil 42 is electrically connected to a power source (not shown), and a voltage (alternating voltage, an intermittent direct current, or the like) which is periodically changed from the power source is applied to the coil.

Through the driving portion 4, the movable plate 21 is rotated as follows.

First, for example, the alternating voltage is applied to the coil 42 by a power source (not shown). Thereby, a first magnetic field in which the upper side (movable plate 21 side) of the coil 42 becomes an N pole and the lower side thereof becomes an S pole and a second field in which the upper side of the coil 42 becomes an S pole and the lower side thereof becomes an N pole are alternately and periodically generated.

In the first electric field, the movable plate 21 is rotated counterclockwise about the axis line X in FIG. 2 so that the S pole side is separated from the coil 42 while the N pole side of the permanent magnet 41 is attracted to the coil 42 (first state). In contrast, in the second electric field, the movable plate 21 is rotated clockwise about the axis line X in FIG. 2 so that the N pole side is separated from the coil 42 while the S pole side of the permanent magnet 41 is attracted to the coil 42 (second state). The first state and the second state are alternately repeated, and the movable plate 21 is twisted about the axis line X.

### Method of Manufacturing Actuator

For example, the above-described optical scanner 1 may be manufactured as follows. Hereinafter, as an example of the method of manufacturing the actuator, the method of manufacturing the optical scanner 1 will be described with reference to FIG. 6A to 10G. In addition, FIGS. 6A to 8G are each shown according to the cross-section corresponding to FIG. 2, and FIGS. 9A to 10D are each shown according to the cross-section corresponding to FIG. 5.

The method of manufacturing the optical scanner 1 includes the processes of forming the base body 2.

The processes of forming the base body 2 include (A) a process of forming a concave portion 218 and (B) a process of forming the movable plate 21, the support portion 22, and the pair of connecting portions 23 and 24.

Hereinafter, each process will be sequentially described in detail.

### A. Process of Forming Concave Portion 218

—A1—First, as shown in FIG. 6A, a silicon substrate 102 is prepared.

The silicon substrate 102 becomes the base body 2 by being subjected to etching as described below.

Specifically, the silicon substrate 102 has a principal surface configured of the (100) plane of silicon.

### —A2—

Next, as shown in FIG. 6B, a nitride film 51 is formed on an upper surface of the silicon substrate 102, and a nitride film 52 is formed on the lower surface of the silicon substrate 102.

For example, the nitride films 51 and 52 are each configured of SiN.

In addition, methods of forming the nitride films 51 and 52 are each not particularly limited. For example, the methods may use a vapor deposition method such as a plasma chemical vapor deposition (plasma CVD).

Moreover, the thickness of the nitride films 51 and 52 is not particularly limited, and the thickness may be about 0.01 μm or more and 0.2 μm or less.

Moreover, instead of the nitride films 51 and 52, for example, an oxide film configured of SiO may be formed by a thermal oxidation method.

### —A3—

Next, as shown in FIG. 6C, a resist film 61 is formed on the nitride film 51, and as shown in FIG. 6D, a resist film 62 is formed on the nitride film 52.

The resist films 61 and 62 are each configured of a positive or a negative resist material.

### —A4—

Next, the portion corresponding to the formation region of the concave portion 218 of the resist film 62 is removed by exposing or developing the resist film 62. Thereby, as shown in FIG. 6E, a resist film 62A including an opening 621 is obtained.

### —A5—

Next, a portion of the nitride film 52 is removed by etching using the resist film 62A as a mask. Thereby, as shown in FIG. 6F, a nitride film 52A including an opening 521 is obtained.

The etching (method of forming opening 521) is not particularly limited. For example, the etching may include reactive ion etching (RIE), dry etching using CF₄, or the like.

### —A6—

Next, the resist films 61 and 62A are removed. Thereby, as shown in FIG. 6G, the upper surface of the silicon substrate 102 is covered with the nitride film 51, and the lower surface thereof is covered with the nitride film 52A.

The method of removing the resist films 61 and 62 is not particularly limited. For example, the removing method may include washing with sulfuric acid, O₂ ashing, or the like.

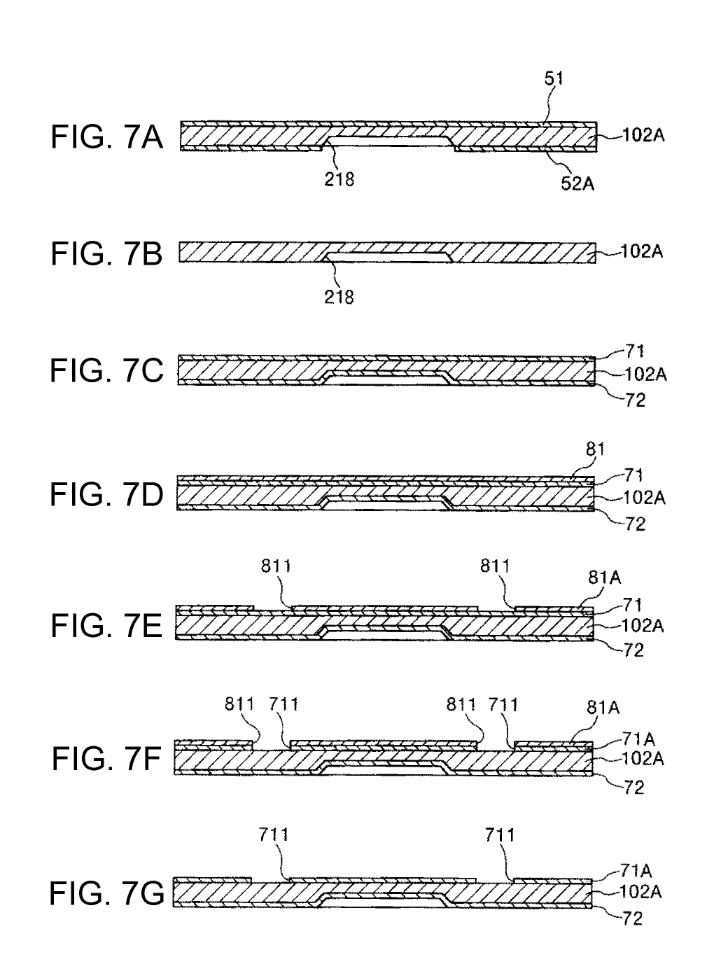

Next, the silicon substrate 102 is etched by using the nitride film 52A as a mask. Thereby, as shown in FIG. 7A, a silicon substrate 102A including the concave portion 218 is obtained.

The etching (method of forming concave portion 218) is not particularly limited. The etching may appropriately use anisotropic etching similar to etching for forming the movable plate 21, the support portion 22, or the like as described below.

The anisotropic etching is not particularly limited. For example, the etching may be performed by wet etching which uses a KOH aqueous solution or the like.

### —A7—

Next, the nitride films 51 and 52A are removed. Thereby, as shown in FIG. 7B, the upper surface and the lower surface of the silicon substrate 102A are exposed.

The method of removing the nitride films 51 and 52A is not particularly limited. For example, similar to the process A5, the reactive ion etching (RIE), the dry etching using CF₄, or the like may be used.

### B. Process of Forming Movable Plate 21, Support Portion 22, or the Like

### —B1—

Next, as shown in FIG. 7C, a nitride film 71 is formed on the upper surface of the silicon substrate 102A, and a nitride film 72 is formed on the lower surface of the silicon substrate 102A.

For example, the nitride films 71 and 72 are each configured of SiN.

In addition, methods of forming the nitride films 71 and 72 are each not particularly limited. For example, similar to the process A2, the methods may use the vapor deposition method such as the plasma chemical vapor deposition (plasma CVD).

In addition, the thickness of the nitride films 71 and 72 is not particularly limited, and the thickness may be about 0.01 μm or more and 0.3 μm or less.

Moreover, instead of the nitride films 71 and 72, for example, an oxide film configured of SiO may be formed by a thermal oxidation method.

### —B2—

Next, as shown in FIG. 7D, a resist film 81 is formed on the nitride film 71.

The resist film 81 is configured of a positive or a negative resist material.

### —B3—

Next, a portion of the resist film 81 is removed by exposing and developing the resist film 81 so that portions corresponding to the formation portions of the movable plate 21, the support portion 22, and the pair of connecting portions 23 and 24 of the resist film 81 remain. Thereby, as shown in FIG. 7E, a resist film 81A including an opening 811 is obtained. Moreover, although not shown in FIG. 7E, an opening which is formed so as to correspond to a gap between the upper ends of the pair of beam members 231 and 232 is also formed on the resist film 81A.

### —B4—

Next, a portion of the nitride film 71 is removed by etching using the resist film 81A as a mask. Thereby, as shown in FIG. 7F, a nitride film 71A including an opening 711 is obtained. Moreover, although not shown in FIG. 7F, an opening which is formed so as to correspond to a gap between the upper ends of the pair of beam members 231 and 232 is also formed on the nitride film 71A.

The etching (method of forming opening 711) is not particularly limited. For example, similar to the process A5, the etching may include the reactive ion etching (RIE), the dry etching using CF₄, or the like.

### —B5—

Next, the resist film 81A is removed. Thereby, as shown in FIG. 7G, the upper surface of the silicon substrate 102A is covered with the nitride film 71A, and the lower surface thereof is covered with the nitride film 72.

The method of removing the resist film 81A is not particularly limited. For example, the removing method may include washing with sulfuric acid, O₂ ashing, or the like.

### —B6—

Next, as shown in FIG. 8A, a resist film 82 is formed on the nitride film 72.

The resist film 82 is configured of a positive or a negative resist material.

### —B7—

Next, a portion of the resist film 82 is removed by exposing and developing the resist film 82 so that portions corresponding to the formation regions of the movable plate 21, the support portion 22, and the pair of connecting portions 23 and 24 of the resist film 82 remain. Thereby, as shown in FIG. 8B, a resist film 82A including an opening 821 is obtained. Moreover, although not shown in FIG. 8B, an opening which is formed so as to correspond to a gap between the lower ends of the pair of beam members 231 and 232 is also formed on the resist film 82A.

### —B8—

Next, a portion of the nitride film 72 is removed by etching using the resist film 82A as a mask. Thereby, as shown in FIG. 8C, a nitride film 72A including an opening 721 is obtained. In addition, although not shown in FIG. 8C, an opening which is formed so as to correspond to a gap between the lower ends of the pair of beam members 231 and 232 is also formed on the nitride film 72A.

The etching (method of forming opening 721) is not particularly limited. For example, similar to the process A5, the etching may include the reactive ion etching (RIE), the dry etching using CF₄, or the like.

### —B9—

Next, the resist film 82A is removed. Thereby, as shown in FIG. 8D, the upper surface of the silicon substrate 102A is covered with the nitride film 71A, and the lower surface thereof is covered with the nitride film 72A.

The method of removing the resist film 82A is not particularly limited. For example, the removing method may include washing with sulfuric acid, O₂ ashing, or the like.

### —B10—

Next, the silicon substrate 102A is anisotropically etched by using the nitride films 71A and 72A as masks. Thereby, as shown in FIG. 8E, the base body 2 is obtained. That is, in the anisotropic etching of the process, the silicon substrate 102A is anisotropically etched from both surface sides via the nitride film 72A which is a first mask and the nitride 71A which is a second mask, and therefore, the movable plate 21, the support portion 22, and the pair of connecting portions 23 and 24 are formed.

The anisotropic etching (method of forming base body 2) is not particularly limited. For example, the etching may be performed by wet etching which uses a KOH aqueous solution or the like.

Here, formation of the connecting portion 23 by the anisotropic etching will be described in detail. In addition, since formation of the connecting portion 24 is similar to the formation of the connecting portion 23, the description thereof is omitted.

As shown in FIGS. 9A to 9D, the nitride film 71A which is used as the mask (second mask) includes a portion 712 which is formed so as to correspond to the formation region in the upper surface of the beam member 231 of the connecting portion 23 and a portion 713 which is formed so as to correspond to the formation region in the upper surface of the beam member 232 of the connecting portion 23, and an opening 714 (second opening) is located between the portion 712 and the portion 713. The opening 714 is formed so as to correspond to the gap between the upper ends of the pair of beam members 231 and 232.

In addition, the nitride film 72A which is used as the mask (first mask) includes a portion 722 which is formed so as to correspond to the formation region in the lower surface of the beam member 231 of the connecting portion 23 and a portion 723 which is formed so as to correspond to the formation region in the lower surface of the beam member 232 of the connecting portion 23, and an opening 724 (first opening) is located between the portion 722 and the portion 723. The opening 724 is formed so as to correspond to the gap between the lower ends of the pair of beam members 231 and 232.

Here, a relationship of the following equation (3) is satisfied when a width of the opening 724 is Wₘ₁ and the thickness of the silicon substrate 102A is T.

$${w}_{m 1} < \frac{T}{tan 54.73 °} \qquad ( 3 )$$

Due to the fact that the relationship equation is satisfied, even when the positional relationships between the nitride film 72A which is the first mask and the nitride film 71A which is the second mask are deviated from each other and a step is generated in the pair of side surfaces to be configured of the (111) plane of silicon of each of the beam members 231 and 232, the step which is formed in the side surface of one side and the step which is formed in the side surface of the other side can be shifted in the thickness direction of the silicon substrate. Thereby, in the obtained actuator, stress concentration which is generated in each of the beam members 231 and 232 when the movable plate 21 is rotated can be alleviated.

The following equation (4) is satisfied when a width of the opening 714 is Wₘ₂.

$$T < \frac{tan 54.73 °}{2} ( {w}_{m 1} + {w}_{m 2} ) \qquad ( 4 )$$

Thereby, the silicon substrate 102A in which the plate surface is configured of the (100) plane of silicon is anisotropically etched from both surface sides, and therefore, the connecting portion 23 which is configured of the pair of beam members 231 and 232 can be simply and reliably formed.

Hereinafter, the anisotropic etching step of the process will be described in detail.

When the anisotropic etching of the process is performed, in a case where the formation positions of the nitride films 71A and 72A used as the masks are not deviated, as shown in FIGS. 9A to 9D, the upper surface of the silicon substrate 102A is etched via the openings 711 and 714 and the lower surface of the silicon substrate 102A is etched via the openings 721 and 724, and the pair of beam members 231 and 232 are formed.

In this case, since the center positions in the width direction of the opening 714 and the opening 724 coincide with each other in the width direction, as shown in FIG. 9D, each side surface of each of the beam members 231 and 232 does not include a step and becomes a constantly inclined surface which is configured of the (111) plane of silicon.

On the other hand, when the anisotropic etching of the process is performed, in a case where the formation positions of the nitride films 71A and 72A used as the masks are deviated, as shown in FIGS. 10A to 10D, the upper surface of the silicon substrate 102A is etched via the openings 711 and 714 and the lower surface of the silicon substrate 102A is etched via the openings 721 and 724, and the pair of beam members 231 and 232 are formed.

In this case, since the center positions in the width direction of the opening 714 and the opening 724 are different from each other in the width direction, as shown in FIG. 10D, a step 2315 is formed in the side surface of one side of the beam member 231, and a step 2316 is formed in the side surface of the other side of the beam member 231. In addition, similar to this, a step 2325 is formed in the side surface of one side of the beam member 232, and a step 2326 is formed in the side surface of the other side of the beam member 232.

As described above, since the width of the opening 724 of the nitride film 72A used as the mask is formed so as to satisfy equation (3), the step 2316 is formed to the nitride film 72A side (lower side) rather than the center in the thickness direction of the silicon substrate 102A.

In contrast, since the widths of the opening 711 of the nitride film 71A and the opening 721 of the nitride film 72A are too much greater than the thickness of the silicon substrate 102A, the step 2315 is formed in the center in the thickness direction of the silicon substrate 102A.

Thereby, the positions of the step 2315 and the step 2316 in the thickness direction of the silicon substrate 102A are different from each other. Similarly, the positions of the step 2325 and the step 2326 in the thickness direction of the silicon substrate 102A are different from each other.

In this way, since the positions of the step 2315 and the step 2316 in the thickness direction of the silicon substrate 102A are different from each other, it is possible to prevent or suppress stress from being concentrated in the center portion in the thickness direction of the beam member 231 when the movable plate 21 is rotated. Similarly, it is possible to prevent or suppress stress from being concentrated in the center portion in the thickness direction of the beam member 232 when the movable plate 21 is rotated. As a result, it is possible to prevent the connecting portion 23 from being damaged due to the stress concentration at the time of the driving. Similarly, it is possible to prevent the connecting portion 24 from being damaged due to the stress concentration at the time of the driving.

If the width of the opening 724 does not satisfy equation (3), all steps 2315, 2316, 2325, and 2326 are formed in the center position in the thickness direction of the silicon substrate 102A. That is, the positions in the thickness direction of the silicon substrate 102A of the steps 2315, 2316, 2325, and 2326 are the same as one another. Thereby, there is a concern that the connecting portions may be damaged due to the stress concentration at the time of the driving.

### —B11—

Next, the nitride films 71A and 72A are removed. Thereby, as shown in FIG. 8F, the upper surface and the lower surface of the base body 2 are exposed.

The method of removing the nitride films 71A and 72A is not particularly limited. For example, similar to the process A5, the reactive ion etching (RIE), the dry etching using CF₄, a wet process with hot phosphoric acid, or the like may be used.

Moreover, processing which rounds the corners of the base body 2 is performed if necessary.

The processing (round processing) is not particularly limited. For example, isotropic etching with hydrofluoric acid, nitric acid, and acetic acid (or water), heat treatment (under reduced pressure, about 1000 to 1200° C., and Ar atmosphere in which H₂ is introduced), or the like may be used.

Next, as shown in FIG. 8G, the permanent magnet 41 is fixed on the lower surface of the movable plate 21 via an adhesive. Moreover, a hard magnetic material is fixed on the lower surface of the movable plate 21 via an adhesive, thereafter, the permanent magnet 41 may be achieved by magnetizing the hard magnetic material.

In addition, a metal film is formed on the movable plate 21, and the light reflecting portion 211 is formed. The method of forming the metal film is not particularly limited. For example, a dry plating method such as vacuum deposition, sputtering (low temperature sputtering), or ion plating, a wet plating method such as electrolytic plating, or electroless plating, a thermal spraying method, bonding of a metal foil, or the like may be used.

Moreover, although not shown, the coil 42 is provided on the support body 3, and the support body 3 and the base body 2 are bonded to each other.

According to the above-described processes, the optical scanner 1 is obtained.

According to the method of manufacturing the optical scanner 1 as described above, since equation (3) is satisfied, in the obtained optical scanner 1 (actuator), it is possible to alleviate the stress concentration which is generated in each of the beam members 231, 232, 241, and 242 when the movable plate 21 is rotated.

According to the optical scanner 1 (actuator) according to the first embodiment described above, since the movable plate 21 is formed in a cross shape in a plan view, it is possible to suppress the moment of inertia at the time of the rotation of the movable plate 21 while securing the light reflection region of the movable plate 21.

In addition, the width in the cross-section of each of the connecting portions 23 and 24 is gradually increased from the side of one side surface of the movable plate 21 to the side of the other side surface, and the movable plate 21 and the pair of connecting portions 23 and 24 can be simply formed with high accuracy by anisotropically etching the silicon substrate.

### Second Embodiment

Next, a second embodiment of the invention will be described.

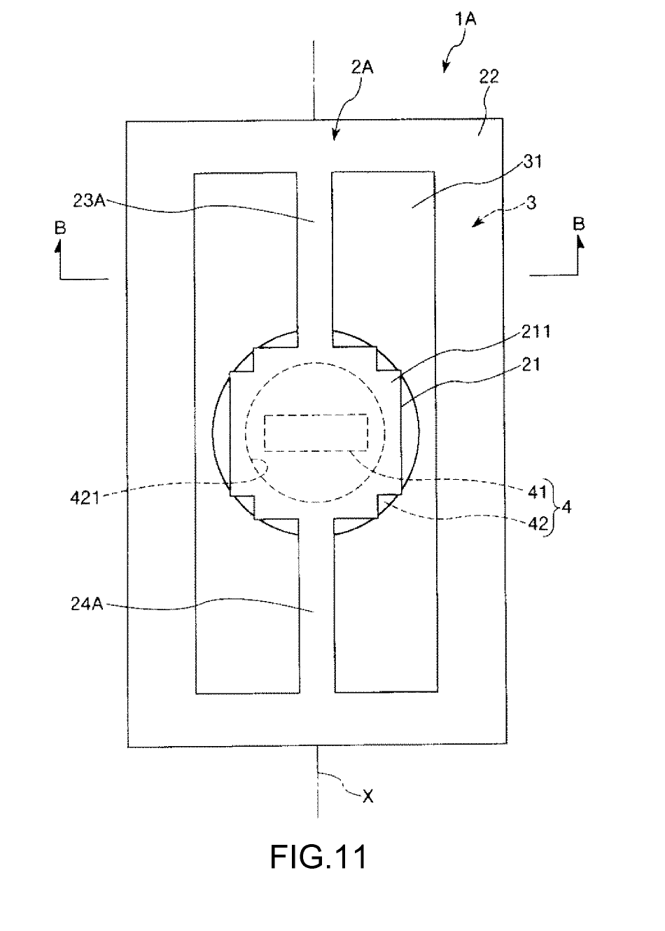

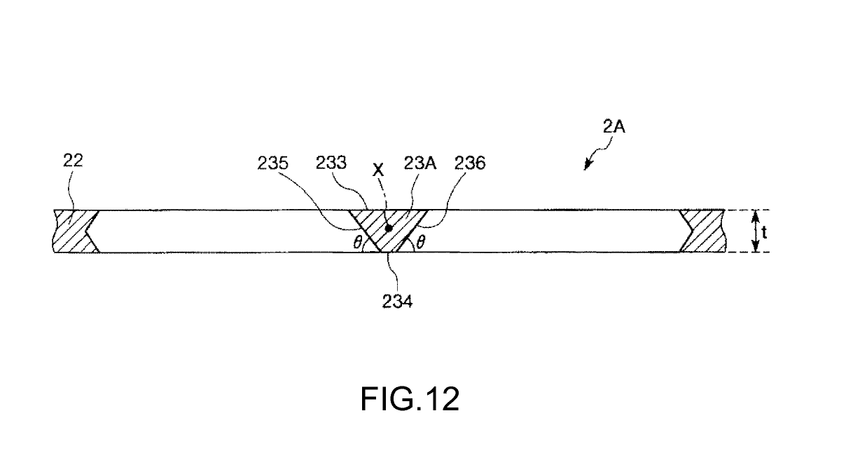

FIG. 11 is a plan view showing an optical scanner according to the second embodiment of the invention, and FIG. 12 is a partially enlarged cross-sectional view taken along a line B-B of FIG. 11.

Hereinafter, components of the optical scanner of the second embodiment which are different from those of the optical scanner of the above-described first embodiment will be described, and those the same as each other are omitted.

The optical scanner of the second embodiment is substantially the same as the optical scanner 1 of the first embodiment except that the cross-sectional shapes of the connecting portions are different from each other. In addition, the configurations which are similar as those of the above-described embodiment are denoted by the same reference numerals.

As shown in FIG. 11, an optical scanner 1A of the second embodiment includes a base body 2A including a vibration system. The base body 2A includes the movable plate 21, the support portion 22, and a pair of connecting portions 23A and 24A which rotatably connect the movable plate 21 to the support portion 22.

Hereinafter, the connecting portion 23A will be described as the representative, since the connecting portion 24A is similar to the connecting portion 23A, the description thereof is omitted.

The connecting portion 23A is provided along the axis line X. In addition, the cross-sectional shape of the connecting portion 23A is a trapezoid.

More specifically, when viewed from the direction parallel to the axis line X (in other words, when viewed from a cross-section shown in FIG. 12), the connecting portion 23A is formed in a shape which is symmetrical (bilaterally symmetrical in FIG. 12) with respect to a line which vertically extends and passes through the axis line X.

Moreover, in the cross-section shown in FIG. 12, a width of the entire connecting portion 23A is widened from the lower side toward the upper side.

In addition, the outer shape of the cross-sections of the connecting portion 23A includes a pair of sides along the (100) plane of silicon and a pair of sides along the (111) plane of silicon. That is, in the connecting portion 23A, an upper surface 233 and a lower surface 234 are each configured of the (100) plane of silicon, and a pair of side surfaces 235 and 236 are each configured of the (111) plane of silicon. Here, the angle θ of each of the side surfaces 235 and 236 which are inclined with respect to the upper surface 233 or the lower surface 234 becomes 54.73°. Similar to the connecting portion 23 of the above-described first embodiment, the connecting portion 23A having the cross-sectional shape can be simply formed with high accuracy by anisotropically etching the silicon substrate in which the plate surface is configured of the (100) plane of silicon.

Also according to the optical scanner 1A of the above-described second embodiment, it is possible to decrease the moment of inertia at the time of the rotation of the movable plate while securing the light reflection region, and dimensional accuracy of the movable plate and the pair of connecting portions can be simply improved.

### Third Embodiment

Next, a third embodiment of the invention will be described.

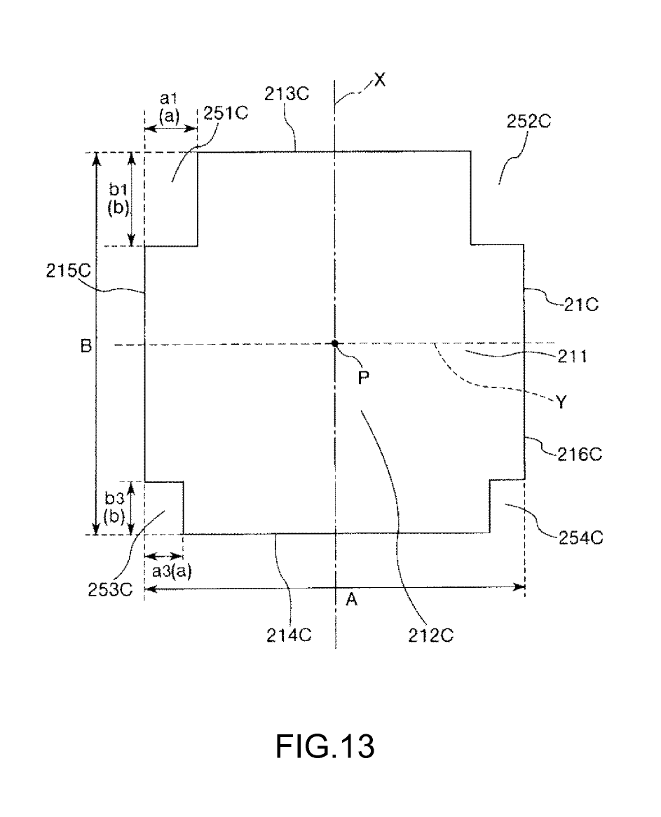

FIG. 13 is a plan view for illustrating a movable plate which is included in a scanner according to the third embodiment of the invention.

Hereinafter, components of the optical scanner of the third embodiment which are different from those of the above-described optical scanners will be described, and those that are the same are omitted.

The optical scanner of the third embodiment is substantially the same as the optical scanner 1 of the first embodiment except that the movable plate in the shape in the plan view is different from that of the first embodiment. In addition, the configurations which are similar as those of the above-described embodiments are denoted by the same reference numerals.

As shown in FIG. 13, a movable plate 21C included in the optical scanner of the third embodiment includes a main body portion 212C, a pair of protrusions 213C and 214C which protrude from the main body portion 212C to both sides in the direction of the axis line X, and a pair of protrusions 215C and 216C which protrude from the main body portion 212C to both sides in the direction of the line Y. Thereby, the movable 21C is formed in a cross shape in a plan view.

In addition, a removed portion 251C is located between the protrusion 213C and the protrusion 215C in the direction along the outer circumference of the movable plate 21C. Moreover, a removed portion 252C is located between the protrusion 213C and the protrusion 216C in the direction along the outer circumference of the movable plate 21C. In addition, a removed portion 254C is located between the protrusion 214C and the protrusion 216C in the direction along the outer circumference of the movable plate 21C. Moreover, a removed portion 253C is located between the protrusion 214C and the protrusion 215C in the direction along the outer circumference of the movable plate 21C.

In the third embodiment, the movable plate 21C is formed so as to be symmetrical with respect to the axis line X in a plan view from the plate thickness direction. However, the movable plate is formed so as to be asymmetrical with respect to the line Y in the plan view. In addition, hereinafter, the removed portions 251C and 253C will be described as the representative. However, the removed portions 252C and 254C are also similar.

More specifically, a relationship of a1<b1 is satisfied when a length along the direction of the line Y of the removed portion 251C is a1 and a length along the direction of the axis line X of the removed portion 251C is b1. That is, the removed portion 251C is located in a rectangle in which the length along the direction of the axis line X is longer than the length along the direction of the line Y. Thereby, mass at a distal end from the axis line X of the movable plate 21C can be effectively decreased. Thereby, it is possible to effectively suppress the moment of inertia at the time of the rotation of the movable plate 21C.

Similarly, a relationship of a3<b3 is satisfied when a length in the direction of the line Y of the removed portion 253C is a3 and a length in the direction of the axis line X of the removed portion 253C is b3. That is, the removed portion 253C is located in a rectangle in which the length in the direction of the axis line X is longer than the length in the direction of the line Y. Thereby, mass at a distal end from the axis line X of the movable plate 21C can be effectively decreased. Therefore, it is possible to effectively suppress the moment of inertia at the time of the rotation of the movable plate 21C.

Moreover, relationships of a1>a3 and b1>b3 are satisfied. Thereby, when light is inclined with respect to the axis of the axis line X and is incident to the light reflecting portion 211, it is possible to effectively secure the light reflection region.

Moreover, even in the movable plate 21C, the equations (A) and (B) are both satisfied when a length in the direction of the line Y in a plan view of the movable plate 21C is A, a length in the direction of the axis line X of the movable plate 21C is B, the lengths in the direction of the line Y of each of the removed portions 251C to 254C are a, and the lengths in the direction of the axis line X of each of the removed portions 251C to 254C are b.

Also according to the optical scanner of the above-described third embodiment, it is possible to decrease the moment of inertia at the time of the rotation of the movable plate while securing the light reflection region, and dimensional accuracy of the movable plate and the pair of connecting portions can be simply improved.

### Fourth Embodiment

Next, a fourth embodiment of the invention will be described.

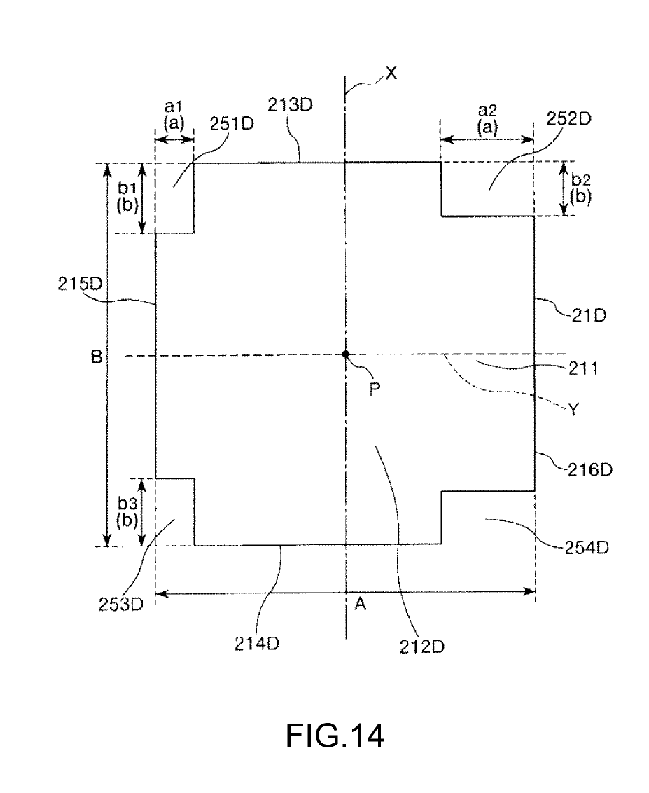

FIG. 14 is a plan view for illustrating a movable plate which is included in a scanner according to the fourth embodiment of the invention.

Hereinafter, components of the optical scanner of the fourth embodiment which are different from those of the optical scanners of the above-described embodiments will be described, and those the same as each other are omitted.

The optical scanner of the fourth embodiment is substantially the same as the optical scanner 1 of the first embodiment except that the shapes in a plan view of the movable plates are different from each other. In addition, the configurations which are similar as those of the above-described embodiment are denoted by the same reference numerals.

As shown in FIG. 14, a movable plate 21D included in the optical scanner of the fourth embodiment includes a main body portion 212D, a pair of protrusions 213D and 214D which protrude from the main body portion 212D to both sides in the direction of the axis line X, and a pair of protrusions 215D and 216D which protrude from the main body portion 212D to both sides in the direction of the line Y. Thereby, the movable 21D is formed in a cross shape in a plan view.

In addition, a removed portion 251D is located between the protrusion 213D and the protrusion 215D in the direction along the outer circumference of the movable plate 21D. Moreover, a removed portion 252D is located between the protrusion 213D and the protrusion 216D in the direction along the outer circumference of the movable plate 21D. In addition, a removed portion 254D is located between the protrusion 214D and the protrusion 216D in the direction along the outer circumference of the movable plate 21D. Moreover, a removed portion 253D is located between the protrusion 214D and the protrusion 215D in the direction along the outer circumference of the movable plate 21D.

In the fourth embodiment, the movable plate 21D is formed so as to be asymmetrical with respect to the axis line X in a plan view. However, the movable plate is formed so as to be symmetrical with respect to the line Y in the plan view. In addition, hereinafter, the removed portions 251D and 252D will be described as the representative. However, the removed portions 253D and 254D are also similar.

More specifically, a relationship of a1<b1 is satisfied when a length in the direction of the line Y of the removed portion 251D is a1 and a length in the direction of the axis line X of the removed portion 251D is b1. That is, the removed portion 251D is located in a rectangle in which the length in the direction of the axis line X is longer than the length in the direction of the line Y. Thereby, mass at a distal end from the axis line X of the movable plate 21D can be effectively decreased. Therefore, it is possible to effectively suppress the moment of inertia at the time of the rotation of the movable plate 21D.

On the other hand, a relationship of a2>b2 is satisfied when a length in the direction of the line Y of the removed portion 252D is a2 and a length in the direction of the axis line X of the removed portion 252D is b2. Thereby, even when area in a plan view of the removed portion 252D is greater than area in a plan view of the removed portion 251D, it is possible to prevent or suppress the center of gravity of the movable plate 21D from being deviated from the axis line X. Therefore, the rotation of the movable plate 21D can be smoothly performed. Moreover, in the fourth embodiment, a relationship of a1×b1<a2×b2 is satisfied.

In addition, even in the movable plate 21D, the equations (A) and (B) are both satisfied when a length in the direction of the line Y in a plan view of the movable plate 21D is A, a length in the direction of the axis line X of the movable plate 21D is B, the lengths in the direction of the line Y of each of the removed portions 251D to 254D are a, and the lengths in the direction of the axis line X of each of the removed portions 251D to 254D are b.

Also according to the optical scanner of the above-described fourth embodiment, it is possible to decrease the moment of inertia at the time of the rotation of the movable plate while securing the light reflection region, and dimensional accuracy of the movable plate and the pair of connecting portions can be simply improved.

For example, the optical scanners described above can be appropriately applied to an image forming apparatus such as a projector, a laser printer, a display for imaging, a bar code reader, or a scanning confocal microscope. As a result, an image forming apparatus including improved drawing characteristics can be provided.

### Image Forming Apparatus

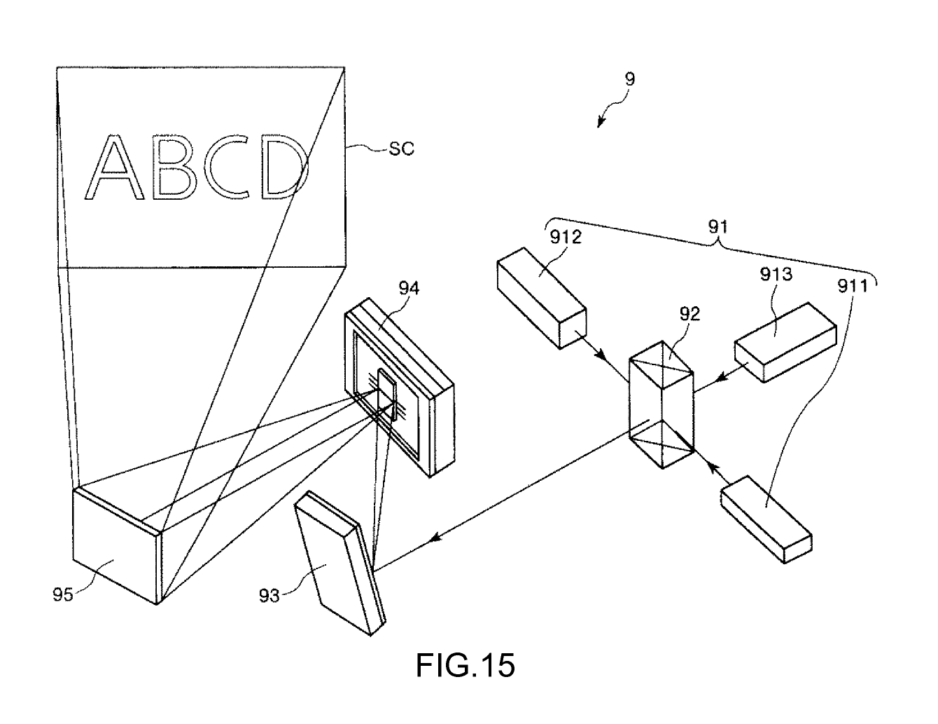

Here, an example of an image forming apparatus will be described with reference to FIG. 15.

FIG. 15 is a schematic view showing an example of a configuration of the image forming apparatus. Moreover, for convenience of the description in the following, a longitudinal direction of a screen SC is referred to as a “longitudinal direction” and a direction perpendicular to the longitudinal direction is referred to as a “vertical direction”.

A projector 9 includes a light source device 91 which emits light such as a laser, a cross dichroic prism 92, a pair of optical scanners 93 and 94 (for example, optical scanner having the configuration similar to that of the optical scanner 1), and a fixed mirror 95.

The light source device 91 includes a red light source device 911 which emits red light, a blue light source device 912 which emits blue light, and a green light source device 913 which emits green light.

The cross dichroic prism 92 is configured by bonding four rectangular prisms and is an optical device which combines light emitted from each of the red light source device 911, the blue light source device 912, and the green light source device 913.

In the projector 9, the cross dichroic prism 92 combines the light, which is emitted from each of the red light source device 911, the blue light source device 912, and the green light source device 913, based on image information from a host computer (not shown), the combined light is scanned by the optical scanners 93 and 94, the scanned light is reflected by the fixed mirror 95, and a color image is formed on the screen SC.

Here, a light scanning of the optical scanners 93 and 94 will be specifically described.

First, the light combined by the cross dichroic prism 92 is horizontally scanned by the optical scanner 93 (main scanning). Moreover, the light which is horizontally scanned is vertically scanned by the optical scanner 94 (sub scanning). Thereby, a two-dimensional color image can be formed on the screen SC. Since the optical scanner according to the invention is used as the optical scanners 93 and 94, it is possible to exert highly improved drawing characteristics.

However, the projector 9 is not limited to the above-described if being configured so as to scan light by the optical scanner and to form image on an object. For example, the fixed mirror 95 may be omitted.

According to the projector 9 which is configured as described above, since the projector includes the optical scanners 93 and 94 including the configurations similar to those of the above-described optical scanner 1, a high quality image can be inexpensively obtained.

As described above, the actuator, the optical scanner, and the image forming apparatus according to the invention are described with reference to the shown embodiments. However, the invention is not limited thereto. For example, in the actuator, the optical scanner, and the image forming apparatus according to the invention, the configuration of each portion may be replaced with any configuration which exerts the same function, and any configuration may be added.

In addition, in the embodiments described above, the case where the movable plate is formed in a shape which is symmetrical with respect to at least one of the center axis of rotation and the line perpendicular to the center axis in a plan view is described, the invention is not limited thereto. For example, the movable plate may be formed in a shape which is asymmetrical with respect to both of the center axis of rotation and the line perpendicular to the center axis in a plan view.

Moreover, in the above-described embodiments, the case where the actuator according to the invention is applied to the optical scanner is described as the example. However, the actuator according to the invention is not limited to this, and for example, the actuator may also be applied to optical devices such as an optical switch and an optical attenuator.

Moreover, in the above-described embodiments, the configuration in which the driving portion which rotates the movable plate adopts the moving magnet type electromagnetic drive system is described as the example. However, the driving portion may adopt a moving coil type electromagnetic drive system. In addition, the driving portion may adopt a driving system such as an electrostatic drive system and a piezoelectric drive system other than the electromagnetic drive system.

The entire disclosure of Japanese Patent Application No. 2011-084839 filed Apr. 6, 2011 is incorporated by reference.

What is claimed is:

1. An actuator comprising:
a movable portion which can twist around an axis;
a connecting portion which extends from the movable portion and is torsionally deformable according to the twisting of the movable portion; and
a support portion which supports the connecting portion,
wherein the movable portion has a cross shape in a plan view, and
a cross-sectional width of the connecting portion perpendicular to the axis gradually increases from a first surface of the movable portion toward a second surface of the movable portion opposite the first surface.

2. The actuator according to claim 1,
wherein an outer shape of the movable portion in the plan view is configured of an edge parallel to the axis and an edge perpendicular to the axis.

3. The actuator according to claim 1,
wherein the movable portion, the support portion, and the connecting portion anisotropically etched portions of a silicon substrate.

4. The actuator according to claim 3,
wherein the second surface of the movable portion is configured of a (100) plane of silicon.

5. The actuator according to claim 3,
wherein side surfaces of the movable portion are configured of a (111) plane of silicon.

6. The actuator according to claim 5,
wherein the side surfaces of the movable portion include a groove having a V shape in a cross-section perpendicular to the second surface of the movable portion.

7. The actuator according to claim 3,
wherein a surface of the connecting portion is configured of a (100) plane and a (111) plane of silicon.

8. The actuator according to claim 1,
wherein the connecting portion includes two beams.

9. The actuator according to claim 8,
wherein a cross-section of each beam perpendicular to the axis is a parallelogram, and
a distance between the two beams gradually increases from the first surface of the movable portion toward the second surface of the movable portion.

10. The actuator according to claim 1,
wherein a cross-section of the connecting portion perpendicular to the axis is a trapezoid.

11. The actuator according to claim 1,
wherein the movable portion is symmetrical with respect to the axis in the plan view.

12. The actuator according to claim 1,
wherein the movable portion is symmetrical with respect to a line which passes through a center of the movable portion and is perpendicular to the axis in the plan view.

13. An actuator comprising:
a movable portion which can twist around an axis;
a connecting portion which extends from the movable portion and is torsionally deformable according to the twisting of the movable portion; and
a support portion which supports the connecting portion,
wherein the movable portion has a shape in which each of four corner-portions of a quadrangle is removed in a rectangular shape in a plan view, and
a cross-sectional width of the connecting portion perpendicular to the axis gradually increased from a first surface of the movable portion toward a second surface of the movable portion opposite the first surface.

14. An optical scanner comprising:
a movable portion which includes a light reflecting portion and can twist around an axis;
a connecting portion which extends from the movable portion and is torsionally deformable according to the twisting of the movable portion; and
a support portion which supports the connecting portion,
wherein the movable portion has a cross shape in a plan view, and
a cross-sectional width of the connecting portion perpendicular to the axis gradually increases from a first surface of the movable portion toward a second surface of the movable portion opposite the first surface.

15. An optical scanner comprising:
a movable portion which includes a light reflecting portion and can twist around an axis;
a connecting portion which extends from the movable portion and is torsionally deformable according to the twisting of the movable portion; and
a support portion which supports the connecting portion,
wherein the movable portion has a shape in which each of four corner-portions of a quadrangle is removed in a rectangular shape in a plan view, and
a cross-sectional width of the connecting portion perpendicular to the axis gradually increases from a first surface of the movable portion toward a second surface of the movable portion opposite the first surface.

16. An image forming apparatus comprising:
a light source which emits light; and
an optical scanner which scans the light from the light source,
wherein the optical scanner includes:
a movable portion which includes a light reflecting portion and can twist around an axis;
a connecting portion which extends from the movable portion and is torsionally deformable according to the twisting of the movable portion; and
a support portion which supports the connecting portion,
the movable portion has a cross shape in a plan view, and
a cross-sectional width of the connecting portion perpendicular to the axis gradually increases from a first surface of the movable portion toward a second surface of the movable portion opposite the first surface.

17. An image forming apparatus comprising:
a light source which emits light; and
an optical scanner which scans the light from the light source,
wherein the optical scanner includes:
a movable portion which includes a light reflecting portion and can twist around an axis;
a connecting portion which extends from the movable portion and is torsionally deformable according to the twisting of the movable portion; and
a support portion which supports the connecting portion,
the movable portion has a shape in which each of four corner-portions of quadrangle is removed in a rectangular shape in a plan view, and
a cross-sectional width of the connecting portion perpendicular to the axis gradually increases from a first surface of the movable portion toward a second surface of the movable portion opposite the first surface.
